(19) United States
(12) Patent Application Publication
(10) Pub. No.: US 2013/0113861 A1
(43) Pub. Date: May 9, 2013

(54) IMAGE FORMING APPARATUS

(71) Applicants: Makoto Kikura, Kanagawa (JP); Tsuguyori Kemma, Kanagawa (JP); Norikazu Yanase, Kanagawa (JP)

(72) Inventors: Makoto Kikura, Kanagawa (JP); Tsuguyori Kemma, Kanagawa (JP); Norikazu Yanase, Kanagawa (JP)

(21) Appl. No.: 13/653,812

(22) Filed: Oct. 17, 2012

(30) Foreign Application Priority Data
Nov. 9, 2011 (JP) 2011-245364

(51) Int. Cl. B41J 23/00

(52) U.S. Cl. 347/37

(57) ABSTRACT

An image forming apparatus including a carriage having a contact portion and an image forming unit that ejects liquid onto a recording medium to form an image on the recording medium, a height adjustment mechanism provided to the carriage to change a height of the carriage, a guide member to support the height adjustment mechanism and to guide the carriage in a main scanning direction, and an impact reduction member provided to the guide member that is contacted by the contact portion of the carriage upon adjustment of the height of the carriage by the height adjustment mechanism to temporarily hold the carriage as the carriage is lowered from an upper position to a lower position by the height adjustment mechanism.

### CROSS-REFERENCE TO RELATED APPLICATIONS

This patent application is based on and claims priority pursuant to 35 U.S.C. §119 to Japanese Patent Application No. 2011-245364, filed on Nov. 9, 2011, in the Japan Patent Office, the entire disclosure of which is hereby incorporated by reference herein.

### BACKGROUND OF THE INVENTION

1. Field of the Invention

Exemplary aspects of the present invention generally relate to an inkjet-type image forming apparatus in which a recording head that ejects liquid droplets onto a recording medium is installed in a carriage to form an image on the recording medium.

2. Description of the Related Art

One type of image forming apparatus such as a printer, copier, plotter, facsimile machine, or multifunction device having two or more of these capabilities is an inkjet recording device. The inkjet recording device employs a recording head that ejects droplets of recording liquid such as ink onto a sheet of a recording medium to form an image on the sheet.

Such inkjet-type image forming apparatuses often include a mechanism that changes the height of the recording head with respect to a conveyance member that conveys the recording medium, so that a gap between a nozzle face of the recording head in which multiple nozzles are formed and the surface of the conveyance member is adjustable to accommodate relatively thick recording media such as envelopes, cardboard, or glossy sheets. One example of such a mechanism allows the height of the recording head to be changed manually using a system of cams, links, levers, and so forth. Another example of the mechanism, and one that has become the most common type, automatically changes the height of the recording head by driving gears using a drive source such as a motor. An uncomplicated configuration is demanded for this type of mechanism in order to reduce production costs and make the image forming apparatus more compact.

In addition to correctly positioning the recording head in the vertical direction using the mechanism, it is also very important to reduce any impact on the recording head during the change in the height of the recording head. The recording head is delicate, and the impact on the recording head may cause irregular ejection of ink droplets from the nozzles formed in the recording head.

In order to prevent the above-described problems, the height of the recording head is changed slowly using a drive source such as a motor or by taking advantage of the shape of components that are used to change the height of the recording head. Consequently, however, production costs are increased in the former case while installation space required for the components is increased in the latter case, thus increasing the size of the image forming apparatus.

To reduce the impact on the recording head while the height of the recording head is changed or the recording head is capped, JP-2010-036345-A discloses a technique in which a height switching member and a support member are provided to elastically bias the recording head using the support member.

However, in the above technique, the single recording head needs two height switching members and two support members. In addition, the height switching members protrude beyond the recording head in the horizontal direction, respectively. Consequently, both production cost and installation space of the height switching members are increased, and thus increasing the size of the image forming apparatus.

### SUMMARY OF THE INVENTION

In view of the foregoing, illustrative embodiments of the present invention provide a novel image forming apparatus that can reduce an impact on a carriage mounting a recording head during change in a height of the carriage with an uncomplicated configuration without an increase in production cost and the size of the image forming apparatus.

In one illustrative embodiment, an image forming apparatus includes a carriage including a contact portion and an image forming unit that ejects liquid onto a recording medium to form an image on the recording medium, a height adjustment mechanism provided to the carriage to change a height of the carriage, a guide member to support the height adjustment mechanism and to guide the carriage in a main scanning direction, and an impact reduction member provided to the guide member that is contacted by the contact portion of the carriage upon adjustment of the height of the carriage by the height adjustment mechanism to temporarily hold the carriage as the carriage is lowered from an upper position to a lower position by the height adjustment mechanism.

Additional features and advantages of the present disclosure will become more fully apparent from the following detailed description of illustrative embodiments, the accompanying drawings, and the associated claims.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a perspective view illustrating the external appearance of art example of an image forming apparatus according to an illustrative embodiment;

FIG. 2 is a schematic plan view illustrating an example of a configuration of a mechanical portion of the image forming apparatus illustrated in FIG. 1;

FIG. 3 is a partial perspective view illustrating the configuration of the mechanical portion of the image forming apparatus;

FIG. 4 is a vertical cross-sectional view illustrating an example of a configuration of a carriage included in the image forming apparatus;

FIG. 5 is a perspective view illustrating the configuration of the carriage;

FIG. 6 is a front schematic view of the carriage;

FIG. 7A is a schematic vertical cross-sectional view illustrating a cam member when the carriage is lowered;

FIG. 7B is a schematic vertical cross-sectional view illustrating the cam member when the carriage is lifted;

FIG. 8A is a perspective view illustrating a first rotation guide member;

FIG. 8B is a perspective view illustrating a second rotation guide member;

FIG. 9A is a vertical cross-sectional view illustrating a state before the carriage supported at an upper position by the cam member is lowered;

FIG. 9B is a vertical cross-sectional view illustrating a state in which the carriage is supported at a lower position by the cam member;

FIG. 10 is a vertical cross-sectional view illustrating the configuration of the carriage;

FIG. 11A is a schematic view illustrating the carriage supported at the upper position when viewed from the rear;

FIG. 11B is a schematic view illustrating the carriage during downward movement when viewed from the rear;

FIG. 12 is a vertical cross-sectional view illustrating a state in which a cover is attached to the carriage in the lower position;

FIG. 13 is a schematic view illustrating pin members provided to the carriage according to a first variation when viewed from the rear; and

FIG. 14 is a schematic view illustrating an example of a configuration of an impact reduction member provided to the image forming apparatus according to a second variation when viewed from the rear.

### DETAILED DESCRIPTION OF THE INVENTION

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Illustrative embodiments of the present invention are now described below with reference to the accompanying drawings. In a later-described comparative example, illustrative embodiment, and exemplary variation, for the sake of simplicity the same reference numerals will be given to identical constituent elements such as parts and materials having the same functions, and redundant descriptions thereof omitted unless otherwise required.

It is to be noted that a “sheet” of recording media is not limited to a sheet of paper but also includes any material onto which liquid droplets including ink droplets adhere, such as an OHP sheet.

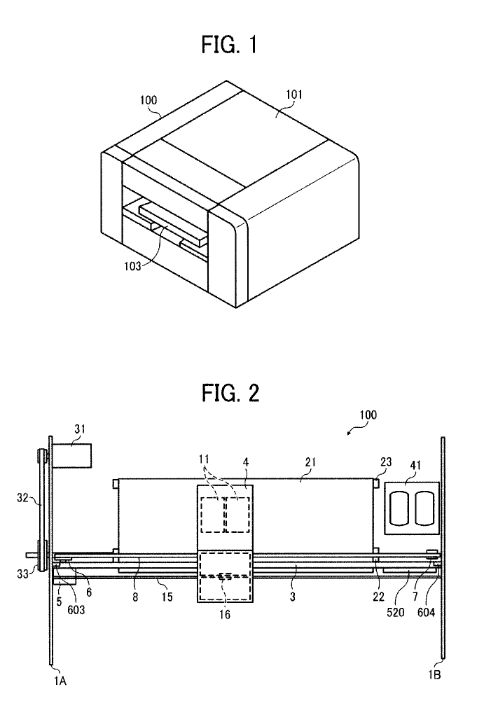

A description is now given of an example of a configuration and operation of an image forming apparatus 100 according to an illustrative embodiment, with reference to FIGS. 1 and 2. FIG. 1 is a perspective view illustrating the external appearance of an example of the image forming apparatus 100. FIG. 2 is a plan view illustrating an example of a configuration of a mechanical portion of the image forming apparatus 100.

The image forming apparatus 100 is a serial-type inkjet recording device. A cover 101 closably openable relative to the body of the image forming apparatus 100 is provided on an upper surface of the image forming apparatus 100. A user opens the cover 101 to access the mechanical portion accommodated within the image forming apparatus 100.

In the mechanical portion, a carriage 4 is slidably supported by a guide member 3 extended between left and right main lateral plates 1A and 1B in a main scanning direction. The carriage 4 is reciprocally movable back and forth in the main scanning direction by a main scanning motor 5 via a timing belt 8 wound around a drive pulley 6 and a driven pulley 7.

An image forming unit, which, in the present illustrative embodiment, includes two recording heads 11 each constituted of a liquid droplet ejection head that ejects liquid droplets of a specific color, that is, yellow (Y), cyan (C), magenta (M), or black (K), and a head tank, not shown, that supplies liquid to the liquid ejection head, are mounted on the carriage 4. Nozzle arrays each constituted of multiple nozzles are provided to a nozzle face of each of the recording heads 11 and arrayed in a sub-scanning direction perpendicular to the main scanning direction, such that the recording heads 11 eject liquid droplets of the specified colors vertically downward.

An encoder scale 15 is disposed along the main scanning direction of the carriage 4, and an encoder sensor 16 constructed of a transmissive photosensor that reads a positional identifier, that is, a scale in the encoder scale 15, is mounted on the carriage 4.

A conveyance belt 21 that conveys a recording medium in the sub-scanning direction is disposed below the carriage 4. The conveyance belt 21 is constructed of an endless belt wound around a conveyance roller 22 and a tension roller 23. The conveyance roller 22 is rotatively driven by a sub-scanning motor 31 via a timing belt 32 and a timing pulley 33 to rotate the conveyance belt 21 in the sub-scanning direction, that is, a direction of conveyance of the recording medium.

A maintenance/recovery mechanism 41 that maintains the nozzles of the recording heads 11 is provided on one side of the mechanical portion next to the conveyance belt 21 in the main scanning direction of the carriage 4. The maintenance/recovery mechanism 41 includes a cap member that covers the nozzle face of each of the recording heads 11, a wiper that wipes off the nozzle face, and an ink receiver to which liquid droplets not used for image formation are ejected in order to remove viscous liquid from the nozzles.

The image forming apparatus 100 further includes a sheet feeder, not shown, that sequentially feeds recording media to the conveyance belt 21, and a discharge tray 103 to which the recording medium having an image formed thereon by the image forming unit is discharged.

In the image forming apparatus 100, the recording medium fed from the sheet feeder is intermittently conveyed by the conveyance belt 21. The recording heads 11 are driven based on image signals while the carriage 4 is moved in the main scanning direction so that liquid droplets are ejected from the recording heads 11 onto the recording medium, which remains stationary, so as to form a single line of an image to be formed on the recording medium. Thereafter, the conveyance belt 21 conveys the recording medium by a predetermined amount to perform image formation of the next line. The above-described processes are repeated to form the image on the recording medium. Upon completion of image formation, the recording medium having the image thereon is discharged to the discharge tray 103.

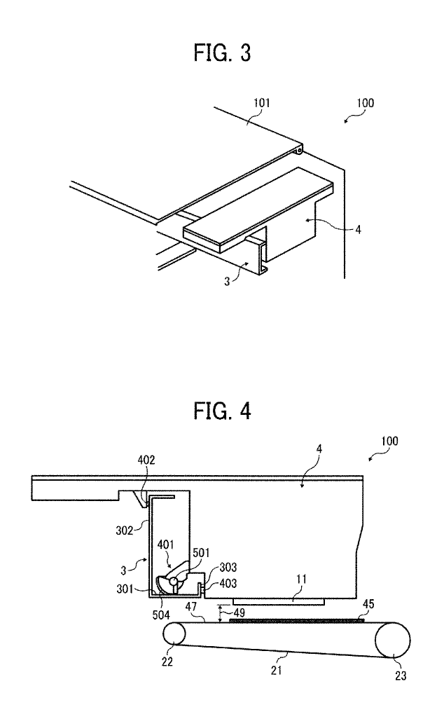

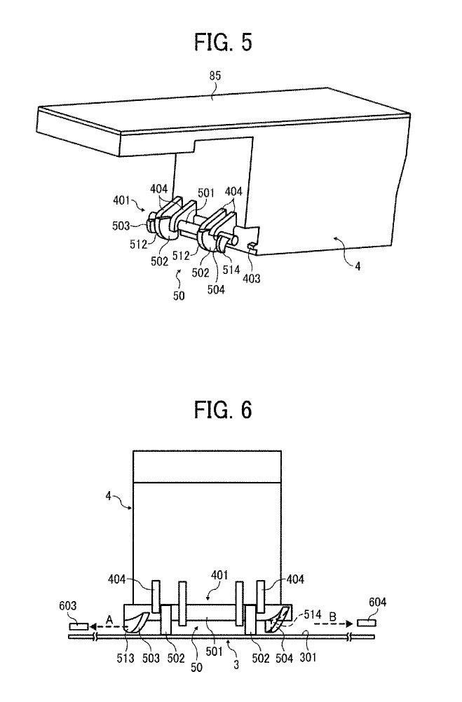

A description is now given of a configuration that supports the carriage 4 and a height adjustment mechanism 50 that adjusts a height of the carriage 4 in the image forming apparatus 100, with reference to FIGS. 3 to 6. FIG. 3 is a partial perspective view illustrating the configuration of the mechanical portion illustrated in FIG. 2. FIG. 4 is a vertical cross-sectional view illustrating an example of a configuration of the carriage 4 included in the image forming apparatus 100. FIG. 5 is a perspective view illustrating the configuration of the carriage 4. FIG. 6 is a front schematic view of the carriage 4.

The guide member 3 is formed of a flanged metal plate and has conjoined planar support surfaces each slidably guiding the carriage 4, which, in the present illustrative embodiment, are a first guide surface 301, a second guide surface 302, and a third guide surface 303. The carriage 4 has a first slide member 401 including the height adjustment mechanism 50 and slidably supported by the first guide surface 301, a second slide member 402 that slidably contacts the second guide surface 302, and a third slide member 403 that slidably contacts the third guide surface 303. The first guide surface 301 of the guide member 3 determines the position of the carriage 4 in a vertical direction. The second guide surface 302 receives torque from the carriage 4 caused by the weight of the carriage 4 itself to prevent rotation of the carriage 4 relative to the guide member 3. The third guide surface 303 determines the position of the carriage 4 in the sub-scanning direction.

Referring to FIG. 4, the carriage 4 mounting the recording heads 11 therein is guided along the guide member 3 to form an image on a recording medium 45 conveyed on a conveyance surface 47 of the conveyance belt 21. At this time, a gap 49 is formed between the nozzle faces of the recording heads 11 and the conveyance surface 47 of the conveyance belt 21. The gap 49 appropriate for each image formation differs depending on the type of the recording medium 45. For example, when an image is formed on a thick recording medium such as an envelope or a glossy sheet after image formation on a thin recording medium, the carriage 4 needs to be lifted to increase the gap 49 between the nozzle faces of the recording heads 11 and the conveyance surface 47 of the conveyance belt 21. By contrast, when an image is formed on the thin recording medium after image formation on the thick recording medium, the carriage 4 needs to be lowered to reduce the gap 49 between the nozzle faces of the recording heads 11 and the conveyance surface 47 of the conveyance belt 21.

The first slide member 401 of the carriage 4 has a rotary shaft member 501 extending in the main scanning direction. The rotary member 501 is rotatably held by four holding members 404 each fixed to the carriage 4. Two cam members 502 each having a slide surface 512 that slidably contacts the first guide surface 301 of the guide member 3 are provided to the rotary member 501. The rotary member 501 further includes first and second rotation guide members 503 and 504 respectively having curved contact parts 513 and 514 formed around the rotary member 501. The cam members 502 and the first and second rotation guide members 503 and 504 together constitute the height adjustment mechanism 50.

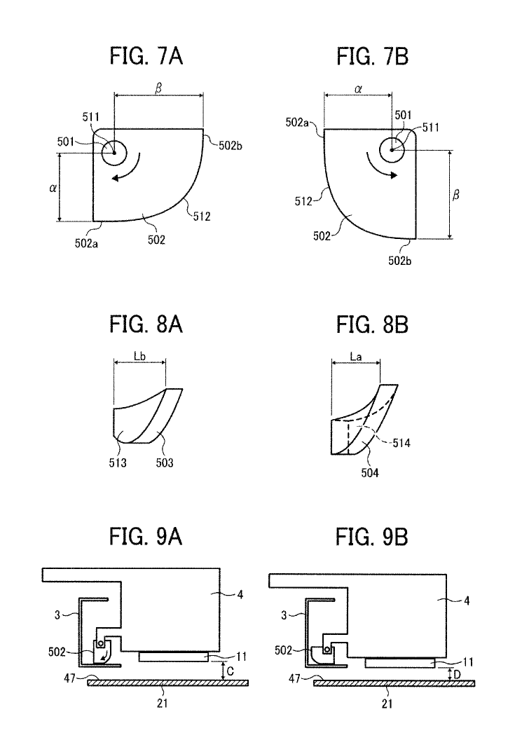

FIG. 7A is a schematic vertical cross-sectional view illustrating the cam member 502 when the carriage 4 is lowered. FIG. 7B is a schematic vertical cross-sectional view illustrating the cam member 502 when the carriage 4 is lifted. As illustrated in FIGS. 7A and 7B, a distance from the center of rotation 511 of the rotary member 501 to the first guide surface 301 of the guide member 3 is changeable between a distance α and a distance 11 depending on the rotational position of the cam members 502. When a portion 502a of the slide surface 512 of each of the cam members 502 contacts the first guide surface 301 of the guide member 3 so that the distance α is formed between the center of rotation 511 of the rotary member 501 and the first guide surface 301 of the guide member 3 as illustrated in FIG. 7A, the carriage 4 is lowered to a lower position in the vertical direction. By contrast, when a portion 502b of the slide surface 512 of each of the cam members 502 contacts the first guide surface 301 of the guide member 3 so that the distance β is formed between the center of rotation 511 of the rotary member 501 and the first guide surface 301 of the guide member 3 as illustrated in FIG. 7B, the carriage 4 is lifted to an upper position in the vertical direction.

The first rotation guide member 503 guides the rotary member 501 to rotate in a direction to lift the carriage 4 relative to the first guide surface 301 of the guide member 3 so that the cam members 502 are rotated from the position illustrated in FIG. 7A to the position illustrated in FIG. 7B to increase the gap 49 between the nozzle faces of the recording heads 11 and the conveyance surface 47 of the conveyance belt 21. The second rotation guide member 504 guides the rotary member 501 to rotate in a direction to lower the carriage 4 toward the first guide surface 301 of the guide member 3 so that the cam members 502 are rotated from the position illustrated in FIG. 7B to the position illustrated in FIG. 7A to reduce the gap 49 between the nozzle faces of the recording heads 11 and the conveyance surface 47 of the conveyance belt 21.

FIGS. 8A and 8B are perspective views illustrating the first and second rotation guide members 503 and 504, respectively. The contact part 513 of the first rotation guide member 503 has a sloped portion more gently sloped than a sloped portion of the contact part 514 of the second rotation guide member 504. Thus, in order to rotate the rotary member 501 at the same angle, the first rotation guide member 503 needs to be moved by a distance Lb while the second rotation guide member 504 needs to be moved by a distance La (La<Lb).

Because the carriage 4 is lifted against gravity and needs to be lifted slowly, the first and second rotation guide members 503 and 504 are respectively designed as described above such that it takes more time to lift the carriage 4 than to lower the carriage 4 when the carriage 4 is moved vertically at the same speed.

Accordingly, a first pressing member 603 contactable with the contact part 513 of the first rotation guide member 503 is disposed to the left lateral plate 1A of the image forming apparatus 100, and a second pressing member 604 contactable with the contact part 514 of the second rotation guide member 504 is disposed to the right lateral plate 1B. The second rotation guide member 504 and the second pressing member 604 are disposed to the one end of the image forming apparatus 100 in the math scanning direction in which the maintenance/recovery mechanism 41 is disposed and a home position of the carriage 4 is set. Accordingly, when being moved to the home position, the carriage 4 is lowered so that the recording heads 11 are reliably capped with the cap member, not shown, provided to the maintenance/recovery mechanism 41.

The carriage 4 is moved in a direction indicated by broken arrow A in FIG. 6 so that the contact part 513 of the first rotation guide member 503 contacts the first pressing member 603. Accordingly, the rotary member 501 is rotated and thus the cam members 502 are rotated to the state illustrated in FIG. 7B so that the portion 502b of the slide surface 512 of each of the cam members 502 contacts the first guide surface 301 of the guide member 3. As a result, the carriage 4 is lifted and the gap 49 between the nozzle faces of the recording heads 11 and the conveyance surface 47 of the conveyance belt 21 is increased.

By contrast, the carriage 4 is moved in a direction indicated by broken arrow B in FIG. 6 so that the contact part 514 of the second rotation guide member 504 contacts the second pressing member 604. Accordingly, the rotary member 501 is rotated and thus the cam members 502 are rotated to the state illustrated in FIG. 7A so that the portion 502a of the slide surface 512 of each of the cam members 502 contacts the first guide surface 301 of the guide member 3. As a result, the carriage 4 is lowered and the gap 49 between the nozzle faces of the recording heads 11 and the conveyance surface 47 of the conveyance belt 21 is reduced.

Thus, the above-described uncomplicated configuration allows easy adjustment of the height of the carriage 4 to change the size of the gap 49 between the recording heads 11 and the conveyance belt 21 solely by the vertical movement of the carriage 4.

FIG. 9A is a vertical cross-sectional view illustrating a state before the carriage 4 supported at the upper position by the cam members 502 is lowered. FIG. 9B is a vertical cross-sectional view illustrating a state in which the carriage 4 is supported at the lower position by the cam members 502.

In the state illustrated in FIG. 9A, a gap C is formed between the nozzle faces of the recording heads 11 and the conveyance surface 47 of the conveyance belt 21. When the cam members 502 are rotated in a clockwise direction in FIG. 9A, the carriage 4 is lowered in conformity with the shape of the cam members 502 so that the carriage 4 is supported by the cam members 502 at the lower position as illustrated in FIG. 9B. At the lower position, a gap D is formed between the nozzle faces of the recording heads 11 and the conveyance surface 47 of the conveyance belt 21. Thus, the carriage 4 is moved by a distance H, which is a difference between the distances C and D, during the vertical movement from the upper position to the lower position. The downward movement of the carriage 4 by the distance H causes an impact on the recording heads 11 mounted on the carriage 4. Consequently, the impact on the recording heads 11 due to the weight of the relatively heavy carriage 4 causes irregular ejection of liquid droplets from the nozzles formed in the recording heads 11.

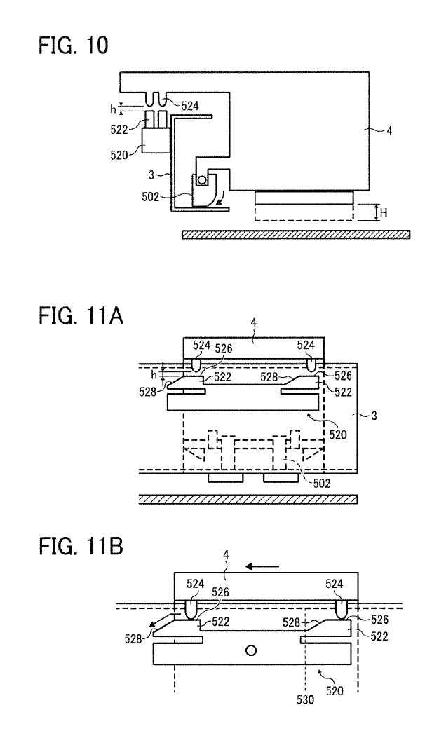

FIG. 10 is a vertical cross-sectional view illustrating the configuration of the carriage 4.

An impact reduction member 520 that supports the carriage 4 when the carriage 4 is lowered is provided to a rear surface of the guide member 3 that guides the carriage 4. Two receivers 522 are provided to an upper portion of the impact reduction member 520 in the front and back in a direction passing through the plane of FIG. 10, respectively. Two contact portions each having a curved leading edge, which, in the present illustrative embodiment, are pin members 524, are provided to the carriage 4 in the front and back in the direction passing through the plane of FIG. 10 at positions corresponding to the two receivers 522 provided to the impact reduction member 520. A distance h between the pin members 524 and the receivers 522 in FIG. 10 is smaller than the distance H.

Conventionally, the carriage has been lowered at one time from the upper position to the lower position by the distance H, with a large impact on the carriage. By contrast, in the present illustrative embodiment, the pin members 524 and the receivers 522 contact each other, respectively, so that the carriage 4 is temporarily supported by the impact reduction member 520 after being lowered by the minute distance h as the carriage 4 is lowered by the distance H, thereby reducing the impact on the carriage 4.

It is preferable that the impact reduction member 520 be formed of a material having good sliding properties, such as polyacetal. When being lowered, first, the carriage 4 slides against a flat portion of the impact reduction member 520, and then slides downward against a sloped portion of the impact reduction member 520 described in detail later. As a result, reduction in the sliding load between the carriage 4 and the impact reduction member 520 can prevent a sudden increase in force and friction between the carriage 4 and the impact reduction member 520.

It is to be noted that, alternatively, the impact reduction member 520 may be provided to an internal portion of the guide member 3 depending on the size of the installation space thereof.

Because the carnage 4 is supported on the guide member 3 by the cam members 502, it is preferable that the impact reduction member 520 be disposed near a virtual vertical plane passing through the cam members 502. For example, in a case in which the impact reduction member 520 is provided apart from the cam members 502 so as to support a right portion of the carriage 4 in FIG. 10, there is a certain distance from the cam members 502, which are most likely to be subjected to the impact, to the right portion of the carriage 4 to which the impact reduction member 520 is provided. Consequently, the impact reduction member 520 possibly supports the carriage 4 only after the carriage 4 is already subjected to a large impact caused by the downward movement of the carriage 4. Therefore, it is preferable that the impact reduction member 520 be disposed near the virtual vertical plane passing through the cam members 502.

FIG. 11A is a schematic view illustrating the carriage 4 supported at the upper position when viewed from the rear. FIG. 11B is a schematic view illustrating the carriage 4 during the downward movement when viewed from the rear.

Each of the two receivers 522 provided to the impact reduction member 520 disposed to the rear surface of the guide member 3 has a holding portion, which in the present illustrative embodiment, is a flat portion 526 that temporarily holds the carriage 4 during the downward movement of the carriage 4, and a transition portion continuous with the flat portion 526, which, in the present illustrative embodiment, is a sloped portion 528 that gently lowers the carriage 4 from the flat portion 526.

The pin members 524, each having a smooth leading edge, are provided to both lateral sides of the carriage 4 to be held by the impact reduction member 520. When the carriage 4 is lowered by the distance h by rotation of the cam members 502, the pin members 524 contact the flat portions 526 of the receivers 522, respectively, so that the carriage 4 is temporarily held by the impact reduction member 520 on the way down. Thereafter, the carriage 4 is further lowered to the lower position.

Each of the receivers 522 has a cutout at the bottom thereof such that the receivers 522 bend when the carriage 4 is lowered to contact the impact reduction member 520, thereby absorbing the impact. Thus, in the present illustrative embodiment, the carriage 4 is lowered by the distance H in stages. Specifically, on the downward movement of the carriage 4 by the distance H, the carriage 4 is temporarily held by the impact reduction member 520 after being lowered by the distance h, which is considerably smaller than the distance FI, thereby considerably reducing the impact on the carriage 4 during the downward movement of the carriage 4. Further, each of the receivers 522 and the pin members 524 are provided at the two positions apart from each other in the main scanning direction, respectively. As a result, the carriage 4 during the downward movement of the carriage 4 is stabilized, thereby reducing vibration.

In FIG. 11B, the carriage 4 is lowered by the rotation of the cam members 502 to contact the flat portions 526 of the receivers 522. When being lowered, first, the carriage 4 is elastically held by the impact reduction member 520, and then is moved to the left in FIG. 11B so that the pin members 524 provided to the carriage 4 slide downward against the sloped portions 528 of the impact reduction member 520. Accordingly, the carriage 4 is gently lowered to the lower position. Specifically, after being lowered by the distance h, the carriage 4 is further lowered by a distance (H-h) while sliding against the sloped portions 528. Thus, the carriage 4 is gently lowered to the lower position by the distance H in total.

A description is now given of the movement of the carriage 4 during the downward movement thereof with reference again to FIGS. 2 and 11A-11B.

The impact reduction member 520 is disposed to the rear surface of the guide member 3 near the maintenance/recovery mechanism 41. In order to lower the carriage 4, first, the carriage 4 is moved in the main scanning direction along the guide member 3 to approach the maintenance/recovery mechanism 41. Next, the carriage 4 is moved to the position illustrated in FIG. 11A, and then is lowered to the position illustrated in FIG. 11B by contacting the second pressing member 604. Thereafter, the carriage 4 is moved apart from the maintenance/recovery mechanism 41 in the main scanning direction and is lowered to the lower position while sliding downward against the sloped portions 528 of the impact reduction member 520.

It is to be noted that although the impact reduction member 520 is disposed near the maintenance/recovery mechanism 41 in the above-described example, the position of the impact reduction member 520 is not limited thereto.

Reference numeral 530 in FIG. 11B denotes a capping position at which the nozzle faces of the recording heads 11 are capped with the cap member of the maintenance/recovery mechanism 41. In a case in which the carriage 4 completes operation after image formation in the lower position, the right pin member 524 of the carriage 4 in FIG. 11B stops at the capping position 530 so that the nozzle faces of the recording heads 11 are capped with the cap member of the maintenance/recovery mechanism 41. By contrast, in a case in which the carriage 4 completes operation after image formation in the upper position, first the carriage 4 is lowered to the lower position and then the right pin member 524 of the carriage 4 in FIG. 11B stops at the capping position 530 so that the nozzle faces of the recording heads 11 are capped with the cap member of the maintenance/recovery mechanism 41.

Thus, the capping position 530 is set at a lower flat portion next to the right sloped portion 528 in FIG. 11B. As a result, the vertical movement of the carriage 4 does not adversely affect capping of the nozzle faces of the recording heads 11 with the maintenance/recovery mechanism 41, and the sloped portion 528 can be provided between the capping position 530 and the right pin member 524 in FIG. 11B.

It is to be noted that although each of the flat portions 526, the sloped portions 528, and the lower flat portion in the above-described example is flat, alternatively, a portion from each of the flat portions 526 to the sloped portions 528, respectively, and a portion from the sloped portion 528 to the lower flat portion may be smoothly curved.

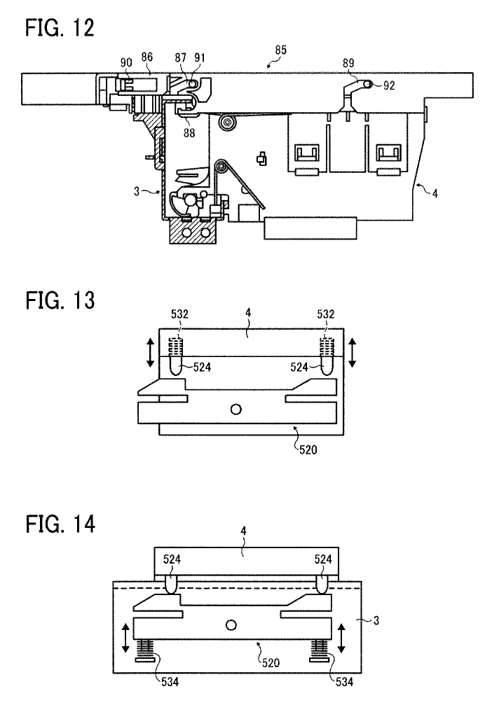

FIG. 12 is a vertical cross-sectional view illustrating a state in which a cover 85 is attached to the carriage 4 in the lower position.

The cover 85 may be attached to the carriage 4 so as to prevent the carriage 4 from slipping off upward from the guide member 3. The cover 85 is placed on the upper surface of the carriage 4 and is inserted into the carriage 4 from right to left in FIG. 12 to be attached to the carriage 4. At this time, a protrusion 90 of the carriage 4 snaps onto an opening of an engagement portion 86 provided to the cover 85 so that the cover 85 is fixed to the carriage 4. Engagement of the protrusion 90 and the engagement portion 86 achieves easy attachment and detachment of the cover 85 to and from the carriage 4 without tools or the like, thereby providing user-friendly configuration.

In addition, protrusions 91 and 92 of the carriage 4 engage reception portions 87 and 89 of the cover 85, respectively, so that fixation of the cover 85 to the carriage 4 is reinforced. Upon detachment of the cover 85 from the carriage 4, the cover 85 is withdrawn to the right in FIG. 12 to disengage the protrusion 90 from the engagement portion 86 and then is lifted.

When the cover 85 is attached to the carriage 4, a hook-shaped slippage prevention portion 88 provided to the cover 85 enters below the guide member 3, thereby preventing the carriage 4 from slipping upward from the guide member 3. When the carriage 4 is in the lower position, the cover 85 is attached only to the carriage 4 and does not contact the guide member 3 so that there is a gap between the slippage prevention portion 88 and the guide member 3. When the carriage 4 is in the upper position, although a distance between the slippage prevention portion 88 and the guide member 3 is reduced, there is still a slight gap therebetween.

However, if the position of each of the flat portions 526 of the receivers 522 is raised so that the distance h is set approximately equal to zero in order to form the slight gap between the slippage prevention portion 88 and the guide member 3 when the carriage 4 is in the upper position, the slippage prevention portion 88 and the guide member 3 may contact each other upon contact of the pin members 524 and the flat portions 526 of the receivers 522 due to installation tolerances or the like, with a force applied to the slippage prevention portion 88 from the guide member 3. Specifically, the pin members 524 receive upward force from the flat portions 526 of the receivers 522 when the distance h is approximately equal to zero. As a result, the slippage prevention portion 88 also receives the upward force from the guide member 3, thereby deforming the slippage prevention portion 88. In order to prevent the above-described problem, it is preferable that the distance h having a certain amount be formed between the pin members 524 and the receivers 522 when the carriage 4 is in the upper position as illustrated in FIG. 11A.

However, in a case in which the cover 85 need not be attached to the carriage 4, the distance h may be set approximately to zero. In such a case, the pin members 524 and the flat portions 526 of the receivers 522 contact each other, respectively, when the carriage 4 is in the upper position. As a result, the carriage 4 need not be lowered by the distance h, thereby protecting the carriage 4 from impact.

Alternatively, in order to set the distance h to approximately zero, each of the sloped portions 528 of the receivers 522 may be extended with gentler angle such that the receivers 522 contact the pin members 524, respectively, when the carriage 4 is in the upper position. As a result, the sloped portions 528 are sloped more gently, thereby more gently lowering the carriage 4.

FIG. 13 is a schematic view illustrating the pin members 524 provided to the carriage 4 according to a first variation when viewed from the rear.

The pin members 524 provided to both left and right sides of the carriage 4, respectively, are formed individually from the carriage 4 as separate members. Each of the pin members 524 is formed of a material having good abrasion resistance, such as metal or resin having sliding properties. The pin members 524 are held by elastic members, which, in the present illustrative embodiment, are springs 532, respectively, provided within the carriage 4. Therefore, when contacting the impact reduction member 520 during the downward movement of the carriage 4, the pin members 524 are bent upward by elasticity of the springs 532, thereby absorbing impact on the carriage 4 during the downward movement.

FIG. 14 is a schematic view illustrating an example of a configuration of the impact reduction member 520 provided to the image forming apparatus 100 according to a second variation when viewed from the rear.

In the second variation, the impact reduction member 520 disposed to the rear surface of the guide member 3 is not fixed to the guide member 3. Specifically, two springs 534 are provided at both left and right sides of a bottom portion of the impact reduction member 520, and the impact reduction member 520 is provided to the rear surface of the guide member 3 via the two springs 534. Each of the springs 534 is an elastic member having elasticity in the vertical direction. Therefore, when the pin members 524 contact the impact reduction member 520 during the downward movement of the carriage 4, the impact reduction member 520 is displaced downward by the elasticity of the springs 534, thereby absorbing the impact on the carriage 4 during the downward movement.

Although the cutouts are formed in the impact reduction member 520 so that the impact reduction member 520 is easily bent as described previously, alternatively, cutouts may not be provided to the impact reduction member 520 having the springs 532 or 534.

As described above, the image forming apparatus 100 according to the foregoing illustrative embodiment includes the carriage 4 having the cans members 502 and the first and second rotation guide members 503 and 504, the first and second pressing members 603 and 604 that drive the first and second rotation guide members 503 and 504, respectively, and the impact reduction member 520 that prevents the recording heads 11 from being subjected to a large impact during the downward movement of the carriage 4. The vertical movement of the carriage 4 is performed by the above-described components in conjunction with the reciprocal movement of the carriage 4 in the main scanning direction. Specifically, the first or second rotation guide member 503 or 504 provided to the carriage 4 is pressed by the first or second pressing member 603 or 604 provided to the image forming apparatus 100, respectively, so that the cam members 502 are rotated to lift or lower the carriage 4. When the carriage 4 is lowered by the rotation of the cam members 502, the carriage 4 is temporarily held by the impact reduction member 520 on the way of the downward movement. Thereafter, the carriage 4 slides downward against the sloped portions 528 of the impact reduction member 520 to be lowered to the lower position. Thus, the gap 49 between the nozzle faces of the recording heads 11 and the conveyance surface 47 of the conveyance belt 21 is reliably adjustable without a large impact on the recording heads 11.

The foregoing illustrative embodiment is applicable not only to the image forming apparatus 100 but also to an image forming apparatus such as a printer, a facsimile machine, and a copier. In addition, the foregoing illustrative embodiment is also applicable to an image forming apparatus using liquid other than ink or an image forming apparatus using fixer or patterning materials.

Elements and/or features of different illustrative embodiments may be combined with each other and/or substituted for each other within the scope of this disclosure and appended claims.

Illustrative embodiments being thus described, it will be apparent that the same may be varied in many ways. Such exemplary variations are not to be regarded as a departure from the scope of the present invention, and all such modifications as would be obvious to one skilled in the art are intended to be included within the scope of the following claims.

The number of constituent elements and their locations, shapes, and so forth are not limited to any of the structure for performing the methodology illustrated in the drawings.

What is claimed is:

1. An image forming apparatus comprising:
a carriage including a contact portion and an image forming unit that ejects liquid onto a recording medium to form an image on the recording medium;
a height adjustment mechanism provided to the carnage to change a height of the carriage;
a guide member to support the height adjustment mechanism and to guide the carriage in a main scanning direction; and
an impact reduction member provided to the guide member that is contacted by the contact portion of the carriage upon adjustment of the height of the carriage by the height adjustment mechanism to temporarily hold the carriage as the carriage is lowered from an upper position to a lower position by the height adjustment mechanism.

2. The image forming apparatus according to claim 1, wherein the impact reduction member includes at least one receiver comprising:
a holding portion that temporarily holds the contact portion of the carriage; and
a transition portion along which the contact portion of the carriage is lowered from the holding portion so that the carriage reaches the lower position.

3. The image forming apparatus according to claim 2, wherein both the receiver of the impact reduction member and the contact portion of the carriage are provided at two separate positions in the main scanning direction.

4. The image forming apparatus according to claim 2, further comprising a maintenance/recovery mechanism that caps the image forming unit,
wherein:
the impact reduction member is disposed near the maintenance/recovery mechanism; and
the contact portion of the carriage is stopped at a position adjacent to the transition portion of the receiver after image formation so that the image forming unit is capped with the maintenance/recovery mechanism at the position.

5. The image forming apparatus according to claim 1, wherein the impact reduction member is flexible.

6. The image forming apparatus according to claim 1, further comprising a cover attached to the carriage to prevent slippage of the carriage upward from the guide member, the cover having a slippage prevention portion,
wherein, in a state in which the carriage is located at the upper position, a gap is formed between the slippage prevention portion and the guide member and between the contact portion of the carriage and the impact reduction member, respectively.

7. The image forming apparatus according to claim 1, further comprising:
a cam member included in the height adjustment mechanism;
a rotation guide member included in the height adjustment mechanism; and
a pressing member that drives the cam member,
wherein, during movement of the carriage in the main scanning direction, the pressing member presses and rotates the rotation guide member so that the cam member is driven to adjust the height of the carriage.

8. The image forming apparatus according to claim 1, wherein the contact portion of the carriage is a pin member having a curved leading edge.

9. The image forming apparatus according to claim 8, wherein the pin member is formed individually from the carriage as a separate member and is held by an elastic member disposed within the carriage.

10. The image forming apparatus according to claim 9, wherein the elastic member is a spring.

11. The image forming apparatus according to claim 1, further comprising an elastic member provided to the guide member,
wherein the impact reduction member is attached to the elastic member.
